(19) United States
(12) Patent Application Publication
(10) Pub. No.: US 2017/0335499 A1
(43) Pub. Date: Nov. 23, 2017

(54) COMBINATION FLOW TUNNEL

(71) Applicant: PELLERIN MILNOR CORPORATION, Kenner, LA (US)

(72) Inventor: Russell H. POY, New Orleans, LA (US)

(21) Appl. No.: 15/601,975

(22) Filed: May 22, 2017

Related U.S. Application Data
(60) Provisional application No. 62/339,457, filed on May 20, 2016.

(51) Int. Cl. D06F 31/00; C11D 11/00

(52) U.S. Cl. CPC D06F 31/005; C11D 11/0017; C11D 11/0064

(57) ABSTRACT

A method of washing fabric articles in a continuous batch tunnel washer, comprises providing a continuous batch tunnel washer having an interior, an intake, a discharge, and a plurality of modules that segment the interior. Fabric articles are moved from the intake to the discharge and through the modules in sequence. One or more modules define a wash zone for washing the fabric articles. One or more of the modules are rinse modules that have a perforated scoop. Some of the modules do not have a perforated scoop. After washing fabric articles, the fabric articles can be rinsed by counter flowing liquid in the washer interior at spaced apart modules and along a flow path that is generally opposite the direction of travel of the fabric articles from the intake to the discharge. Velocity rinsing can also replace a continuous counter flow. To improve rinsing and washing, one or more modules may be dilution zone modules, which receives a flow stream from the rinsing modules via a booster pump. A dilution zone module or drum preferably has a perforated scoop to drain the free water when transferring to the next dilution zone module or drum. Drums or modules without shells (carryover modules) have scoops for fabric article (e.g., linen) transfer with no perforations. Thus, the linen and all water go to the next downstream drum at the carryover modules.

### CROSS-REFERENCE TO RELATED APPLICATIONS

This application claims benefit of U.S. Provisional Patent Application Ser. No. 62/339,457, filed 20 May 2016, which is hereby incorporated herein by reference.

Priority of U.S. Provisional Patent Application Ser. No. 62/339,457, filed 20 May 2016, which is incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

### 1. Field of the Invention

The present invention relates to washing machines. More particularly, the present invention relates to an improved washing machine and method, the washing machine having multiple modules and wherein some modules have perforated scoops, some modules have outer shells and wherein some modules do not have scoops and/or shells.

### 2. General Background

Patents have issued for large commercial type washing machines typically referred to “tunnel washers” or “tunnel batch washers” or “continuous batch tunnel washers”. Examples can be seen in U.S. Pat. Nos. 4,236,393; 9,127,389 (US Patent Application Publication No. 2010/0269267); and U.S. Pat. No. 9,580,854 (US Patent Application Publication No. 2013/0291314), each of which is hereby incorporated herein by reference. Such tunnel washers have multiple modules. In U.S. Pat. No. 4,236,393, each module is a cylindrical casing having a peripheral wall with perforated areas. The '393 patent provides a continuous tunnel batch washer of modular construction with the number of modules varying depending upon installational requirements. Each module includes a drum rotatably supported and driven to oscillate in a predetermined manner during the washing cycle and to rotate unidirectionally during transfer of the load from one module to a succeeding module with a chute or trough arrangement extending between the modules for transferring the wash load from one module to a next successive module. The drum in each module is roller supported and chain driven from a common shaft with a plurality of independent motors driving the shaft by a belt drive with each module including a reduction gear driven from the shaft and having an output driving the sprocket chain for the oscillatable and rotatable drum. A programmed control device provides continuous control of each batch of articles being laundered as they progress to the successive module in the machine. In the '393 patent, all scoops are perforated. Perforated transfer scoops are also discussed in the above listed U.S. Pat. Nos. 9,127,389 and 9,580,854.

Some prior art washing machines are based on counter flow high velocity rinsing after standing bath washing (e.g., see U.S. Pat. No. 8,336,144 (US Patent Application Publication No. 2011/0225741), incorporated herein by reference). The counter flow starts in the last module, or typically the module before the last module, and flows at high velocity sequentially through each upstream module and finally exiting upstream (e.g., at the first module). This requires that all modules have an outer shell for the water to flow in and out. Additionally, there must be a barrier in the lower part of the shell to separate the water between drums. Each module can be a dual use module.

Another prior art tunnel washer type machine is a bottom transfer machine where the drum holding the fabric articles (linen) is also the drum holding the water. There is no outer shell. When the standing bath is finished, the linen (or fabric articles to be cleaned) and all the water is transferred to the next attached module or drum. In the middle of the machine, there are two or more drums that are fitted with an outer shell. The outer shell has a drain valve and water refill valve (i.e. a dilution zone). To achieve the dilution function, the drum is drained and refilled at least once. All of the fabric articles (e.g., linen) and water are transferred to the next contiguous module or drum which also has an outer shell. The water and fabric articles (e.g., linen) can be heated to between about 40 degrees and 80 degrees Celsius. Rinsing is done with counterflow in two or more downstream modules at low velocity typically about 20 to 50 gallons per minute or “GPM” (about 75.70 to 189.27 liters per minute) on a continuous basis. All modules can be single function modules.

The following table lists possibly relevant patents (each hereby incorporated herein by reference) directed to other washing machines including some tunnel washing machines.

| PATENT | | ISSUE DATE |
|---|---|---|
| NO. | TITLE | MM/DD/YYYY |
| 9,580,854 | CONTINUOUS BATCH TUNNEL WASHER AND | 02/28/2017 |
| | METHOD | |
| 9,200,398 | CONTINUOUS BATCH TUNNEL WASHER AND | 12/01/2015 |
| | METHOD | |
| 9,127,389 | CONTINUOUS BATCH TUNNEL WASHER AND | 09/08/2015 |
| | METHOD | |
| 8,635,890 | PEDESTAL WASHING MACHINE | 01/28/2014 |
| 8,370,981 | INTEGRATED CONTINUOUS BATCH TUNNEL | 02/12/2013 |
| | WASHER | |
| 8,336,144 | CONTINUOUS BATCH TUNNEL WASHER AND | 12/25/2012 |
| | METHOD | |
| 7,971,302 | INTEGRATED CONTINUOUS BATCH TUNNEL | 07/05/2011 |
| | WASHER | |
| 7,197,901 | WASHING MACHINE | 04/03/2007 |
| 6,796,150 | INSTALLATION FOR THE WET-TREATMENT OF | 09/28/2004 |
| | LAUNDRY, AND SEAL FOR SUCH AN INSTALLATION | |
| 6,238,516 | SYSTEM AND METHOD FOR CLEANING, | 05/29/2001 |
| | PROCESSING, AND RECYCLING MATERIALS | |
| 5,564,595 | CHEMICAL DISPENSING SYSTEM | 10/15/1996 |
| 5,564,292 | WASHING MACHINE | 10/15/1996 |
| 5,454,237 | CONTINUOUS BATCH TYPE WASHING MACHINE | 10/03/1995 |
| 5,392,480 | WASHING METHOD BY A CONTINUOUS WASHING | 02/28/1995 |
| | MACHINE | |
| 5,211,039 | CONTINUOUS BATCH TYPE WASHING MACHINE | 05/18/1993 |
| 4,984,438 | PROCESSING OF DENIM GARMENTS | 01/15/1991 |
| 4,829,792 | DOUBLE DRUM BATCH WASHING MACHINE | 05/16/1989 |
| 4,522,046 | CONTINUOUS BATCH LAUNDRY SYSTEM | 06/11/1985 |
| 4,485,509 | CONTINUOUS BATCH TYPE WASHING MACHINE | 12/04/1984 |
| | AND METHOD FOR OPERATING SAME | |
| 4,363,090 | PROCESS CONTROL METHOD AND APPARATUS | 12/07/1982 |
| 4,236,393 | CONTINUOUS TUNNEL BATCH WASHER | 12/02/1980 |

### BRIEF SUMMARY OF THE INVENTION

The apparatus and method of the present invention improves the washing and rinsing functions of a bottom transfer type machine. The present invention includes a method of washing fabric articles in a continuous batch tunnel washer, comprising providing a continuous batch tunnel washer preferably having an interior, an intake, a discharge, and a plurality of modules or drums that segment the interior. Fabric articles are moved from the intake to the discharge and through the modules in sequence. One or more modules define a wash zone for washing the fabric articles. One or more of the modules are rinse modules that have a perforated scoop, and some of the modules do not have a perforated scoop. A washing chemical may be added to one or more of the modules. After washing fabric articles, the fabric articles can be rinsed by counter flowing liquid in the washer interior at multiple locations along a flow path that is generally opposite the direction of travel of the fabric articles from the intake to the discharge.

With the present invention, high velocity rinsing can replace a continuous counterflow. Because of the efficiency of the high velocity (e.g., 80 to 180 GPM (302.83 to 681.37 liters per minute)), fewer drums or modules are required for the same level of dilution. In some embodiments, there are a plurality of rinsing modules or rinsing drums. The rinsing modules or drums preferably have perforated scoops and outer shells to improve rinsing efficiency. In one embodiment of the apparatus of the present invention, only one rinsing module or drum is required.

To improve rinsing and washing, one or more modules may be dilution zone modules, which receive a flow stream from rinsing modules preferably via a booster pump. This dilution zone module or drum preferably has a perforated scoop to drain the free water when transferring to the next dilution zone module or drum. Drums or modules without shells (as shown in the drawings) preferably have scoops for fabric article (e.g., linen) transfer with no perforations. These are carryover modules. Thus, the linen and all water preferably go to the next downstream module or drum.

The improvements of the present invention include a much lower manufacturing cost, fewer modules or drums, and improved washing and rinsing functions.

The present invention includes a method of washing fabric articles in a continuous batch tunnel washer, comprising providing a continuous batch tunnel washer preferably having an interior, an intake, a discharge, a plurality of modules, and a volume of liquid. The fabric articles can be moved from the intake to the modules and then to the discharge in sequence. One or more of the modules can have a perforated scoop. In one embodiment, the present invention includes not counter flowing a rinsing liquid in the washer interior for a selected time interval. In one embodiment, counter flowing a rinsing liquid can occur along a flow path that is generally opposite the direction of travel of the fabric articles. In one embodiment, boosting the pressure of the counter flowing rinsing liquid occurs with a booster pump at one or more positions spaced preferably in between the intake and the discharge.

In one embodiment, multiple booster pumps can be provided, each pump boosting counter flowing rinsing liquid flow rate preferably at a different one of said modules.

In one embodiment, there can be multiple said modules preferably with perforated scoops.

In one embodiment, the booster pumps can be spaced apart preferably by more than one module.

In one embodiment, the booster pump preferably discharges liquid into a module that has an outer shell.

In one embodiment, the booster pumps preferably each discharge liquid into a module that does not have a perforated scoop.

In one embodiment, flow can be substantially halted for a time period that is preferably less than about five minutes.

In one embodiment, flow can be substantially halted for a time period that is preferably less than about three minutes.

In one embodiment, flow can be substantially halted for a time period that is preferably less than about two minutes.

In one embodiment, flow can be substantially halted for a time period that is preferably between about twenty and one hundred twenty (20-120) seconds.

The present invention includes a method of washing fabric articles in a continuous batch tunnel washer, comprising providing a continuous batch tunnel washer preferably having an interior, an intake, a discharge, and a plurality of modules that segment the interior. The fabric articles can be moved preferably from the intake to the discharge. Washing chemical can preferably be added to the modules. After a selected time interval, counter flowing liquid can occur in the washer interior preferably along a flow path that is generally opposite the direction of travel of the fabric articles. Counter flowing water through the modules preferably effects a rinse of the fabric articles. Some of the modules can have an outer shell and some of the modules do not have an outer shell.

The present invention includes a method of washing fabric articles in a continuous batch tunnel washer, comprising providing a continuous batch tunnel washer preferably having an interior, an intake, a discharge, and a plurality of modules that segment the interior. The fabric articles can be moved preferably from the intake to the discharge and through the modules in sequence. A washing chemical can preferably be added to the modules. The fabric articles can then be washed. The fabric articles can be rinsed preferably by counter flowing liquid in the washer interior along a flow path that is generally opposite the direction of travel of the fabric articles. One or more of the modules can be rinse modules that preferably have a perforated scoop. In one embodiment, some of the modules do not have a perforated scoop.

The present invention includes a method of washing fabric articles in a continuous batch tunnel washer, comprising providing a continuous batch tunnel washer preferably having an interior, an intake, a discharge, a plurality of modules, and a volume of liquid. The fabric articles can be moved preferably from the intake to the modules and then to the discharge in sequence. One or more of the modules can have a perforated scoop and one or more of the modules preferably has an outer shell. In one embodiment, one or more of the modules does not have a perforated scoop. In one embodiment, counter flowing a rinsing liquid can occur along a flow path that is generally opposite the direction of travel of the fabric articles. In one embodiment, the pressure of the counter flowing rinsing liquid can be boosted preferably with a booster pump at one or more positions spaced in between the intake and the discharge.

In one embodiment, there can be multiple of the modules with perforated scoops.

In one embodiment, the booster pump can discharge liquid into a module that preferably has an outer shell.

In one embodiment, the booster pump can discharge liquid into a module that preferably does not have a perforated scoop.

In one embodiment, flow can be substantially halted for a time period.

In one embodiment, flow can be substantially halted for a time period that is preferably less than about three minutes.

In one embodiment, flow can be substantially halted for a time period that is preferably less than about two minutes.

In one embodiment, flow can be substantially halted for a time period that is preferably between about twenty and one hundred twenty (20-120) seconds.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIGS. 1A-1E illustrate operation of a top transfer tunnel washer;

FIG. 2 is a schematic diagram view of a preferred embodiment of the apparatus of the present invention showing a nine-module apparatus;

FIG. 3 is a schematic diagram view of a preferred embodiment of the apparatus of the present invention showing a twelve-module apparatus;

FIG. 4 is a schematic diagram view of a preferred embodiment of the apparatus of the present invention showing a seven-module apparatus;

FIG. 5 is a schematic diagram view of a preferred embodiment of the apparatus of the present invention showing a twelve-module apparatus;

FIG. 6 is a schematic diagram view of a preferred embodiment of the apparatus of the present invention showing a sixteen-module apparatus;

FIG. 7 is a partial perspective view of a preferred embodiment of the apparatus of the present invention; and

FIG. 8 is a partial perspective view of a preferred embodiment of the apparatus of the present invention.

### DETAILED DESCRIPTION OF THE INVENTION

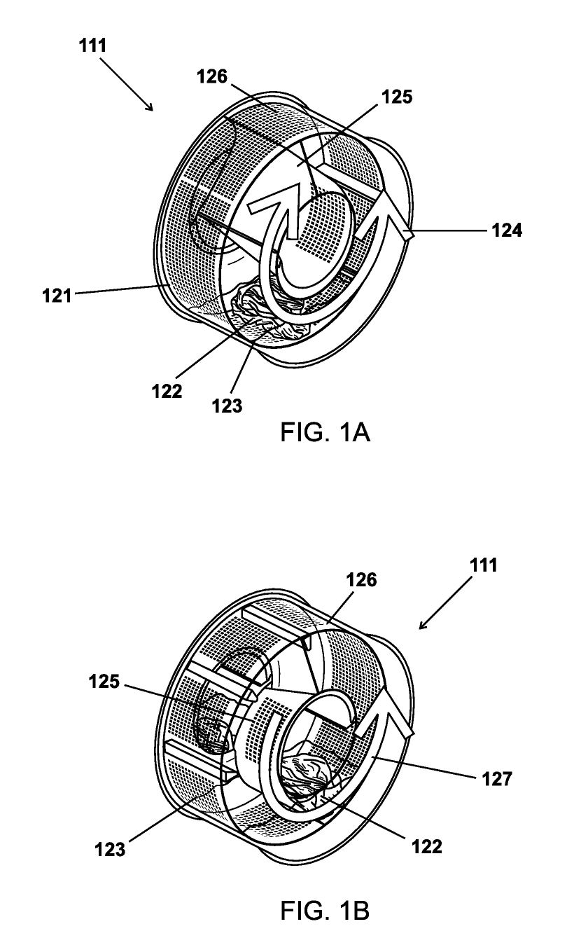

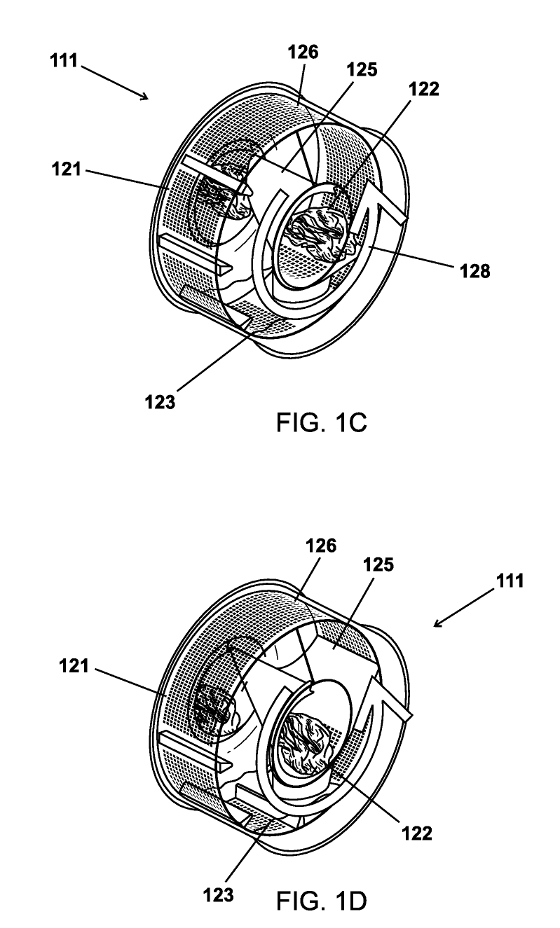

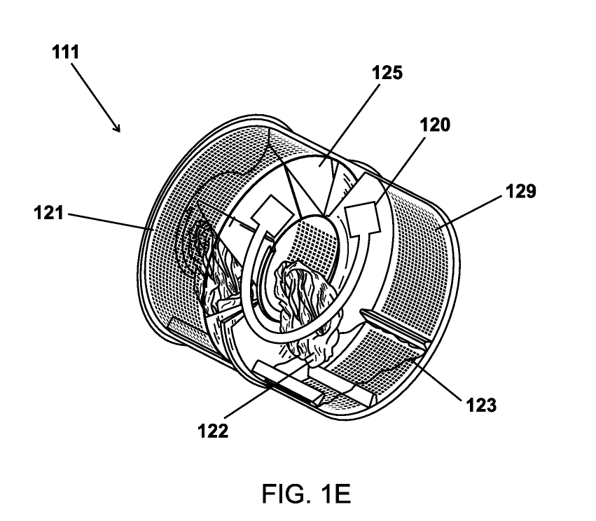

FIGS. 1A-1E illustrate operation of a top transfer tunnel washer 111. In FIG. 1A, the initial step shows a module 121 before a transfer of fabric articles, linens or goods 122 to the next module Immediately before the tunnel washer 111 transfers all the batches of goods forward to the next module, the goods 122 are preferably submerged in the bath liquor 123 at the bottom of the module 121. The tunnel washer 111 imparts mechanical action on the goods preferably by reversing the cylinder 126 through an arc of approximately ¾ of a rotation, as indicated by arrow 124. For this phase of the cycle, the scoop 125, which is preferably part of and rotates with the cylinder 126, preferably does not interact with the goods 122.

After the programmed number of reversals, the tunnel washer cylinder 126 preferably makes a complete rotation counter-clockwise as seen in FIG. 1B and indicated by arrow 127. When the scoop 125 crosses the bottom of the tunnel washer 111, it preferably collects the goods 122 and bath liquor 123.

The counter-clockwise rotation preferably continues, as seen in FIG. 1C and indicated by arrow 128, which preferably lifts the goods 122 off the bottom of the tunnel washer 111. If the scoop 125 is perforated, the bath liquor 123 preferably drains back into the original module 121; otherwise, much of the bath liquor 123 is lifted along with the goods 122.

In FIG. 1D, the shape of the scoop 125 preferably causes the goods 122 to slide forward, preferably toward the next module 129 in the tunnel washer 111. If the scoop 125 is not perforated, a significant amount of bath liquor 123 is preferably also transferred forward in the tunnel washer.

As the scoop 125 rotates preferably to near the top of the tunnel washer (FIG. 1E), the rotation preferably pauses momentarily, as indicated by circular line 120, to let the goods 122 slide into the next module 129. After this pause 120, the tunnel washer 111 preferably resumes operating as shown and described in FIG. 1A.

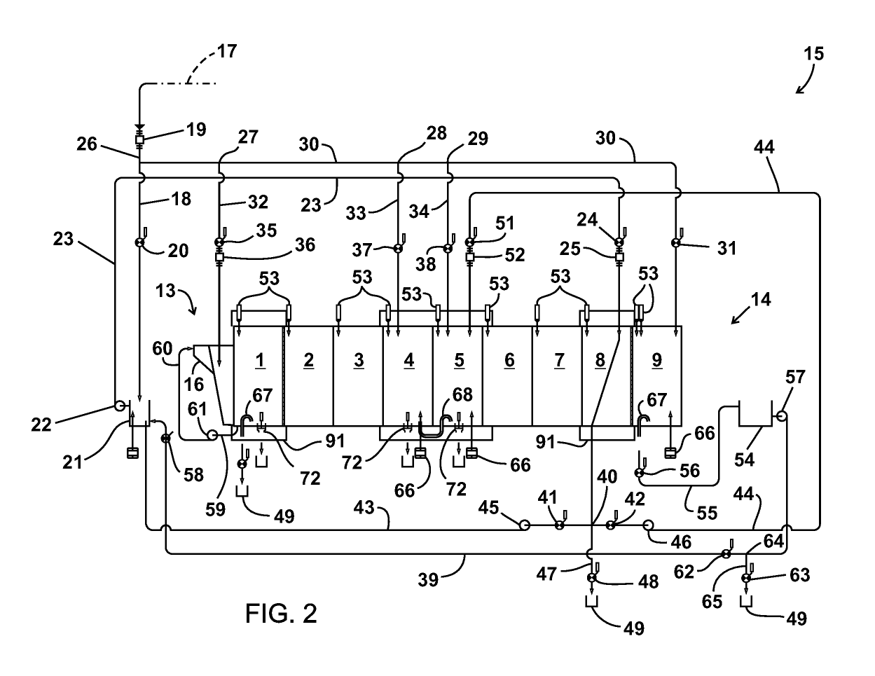

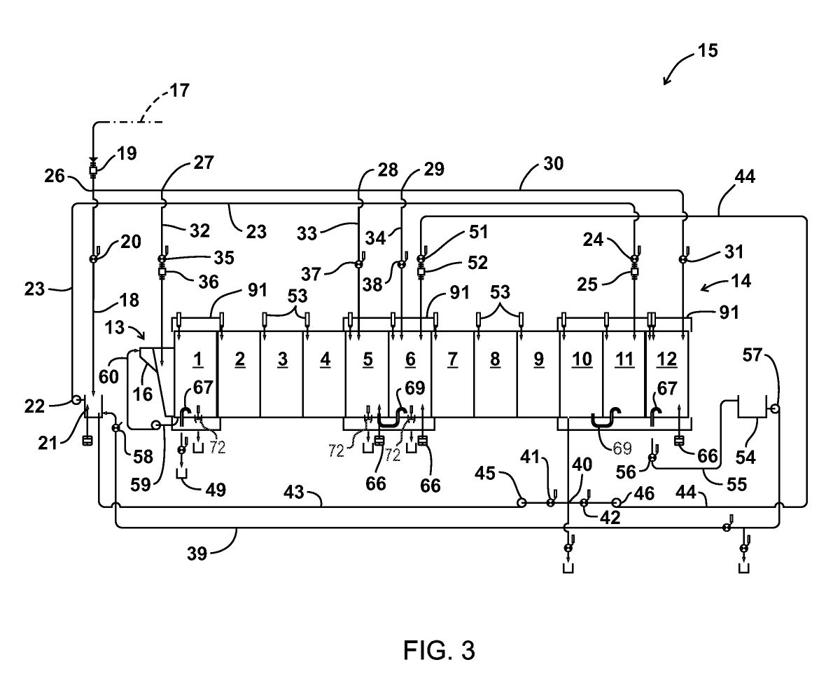

FIGS. 2-3 show a preferred embodiment of the apparatus of the present invention, designated generally by the numeral 15. Washing machine 15 has a plurality of modules or drums. In FIG. 2, the washing machine 15 has nine modules or drums 1, 2, 3, 4, 5, 6, 7, 8 and 9. In FIG. 3, washing machine 15 has twelve modules or drums 1, 2, 3, 4, 5, 6, 7, 8, 9, 10, 11 and 12. Machine 15 has end portions 13, 14. End portion 13 is an inlet end portion or inlet 13 where dirty or soiled fabric articles (e.g., linen articles or goods) are added at hopper 16.

A fresh water source 17 enables fresh water to be added to tank 21 via flow line 18. Flow line 18 can have flow meter 19 and valve 20. Pump 22 enables a discharge of water from tank 21 via flow line 23. Flow line 23 can be provided with valve 24 and flow meter 25. Flow line 30 joins to flow line 18 at tee fitting 26. Line 30 has tee fittings at 27, 28, 29. Flow line 30 can have valve 31. In FIG. 2, flow line 30 discharges into module or drum 9. In FIG. 3, flow line 30 discharges into module 12.

Flow line 32 connects to flow line 30 at tee fitting 27. Flow line 32 can have valve 35 and flow meter 36. Flow line 32 discharges into hopper 16. Flow line 33 connects to flow line 30 at tee fitting 28. Flow line 33 can have valve 37. Flow line 34 connects to flow line 30 at tee fitting 29. Flow line 34 can have valve 38. In FIG. 2, flow line 33 discharges into module 4. In FIG. 3, flow line 33 discharges into module 5. Each of the modules or drums 1, 2, 3, 4, 5, 6, 7, 8, 9 in FIG. 2 and also modules 10-12 in FIG. 3 can have a chemical injector 53 for adding selected chemicals such as detergent and bleach. Steam inlets can be provided at 66. For example, in FIG. 2 there are steam inlets 66 at modules 4-5 and 9. In FIG. 3, there are steam inlets 66 at modules 5-6 and 12. In a preferred embodiment of the present invention, there would be an outer shell 91 where there is steam inlet 66. In FIG. 2, module 1 has an outer shell as do modules 4-5 and 8. In FIG. 2, module 8 or modules 8 and 9 can have an outer shell 91. In FIG. 3, there is an outer shell 91 for module 1, modules 5-6 and for modules 10, 11, and 12.

Extracted water tank 54 receives water that is discharged from final module 9 (for FIG. 2) or module 12 (for FIG. 3). Extracted water tank 54 receives extracted water from an extractor (not shown) such as a centrifuge, press or the like. Such extractors are known and commercially available. Fabric articles containing water exit final module 9 or 12 and transfer to an extractor where water is extracted. Extracted water from final module 9 or 12 is transmitted via flow line 55 to extracted water tank 54. Line 55 can have valve 56. Water can be transmitted from extracted water tank 54 to tank 21 via flow line 39. Pump 57 can be provided in flow line 39. Flow line 39 can have valve 58 which can be placed next to tank 21.

At junction or cross fitting 40, flow can be selected to go to sewer 49 via line 47 and valve 48. Flow can selectively go to line 43 or 44 from junction or cross fitting 40. Line 43 has valve 41 and pump 45. Line 43 transmits water to tank 21. Line 44 has valve 42 and pump 46. Line 44 also has a valve 51 and meter 52. Line 44 transmits water from junction or cross fitting 40 to module 5 in FIG. 2. This water counterflows from module 5 to module 4.

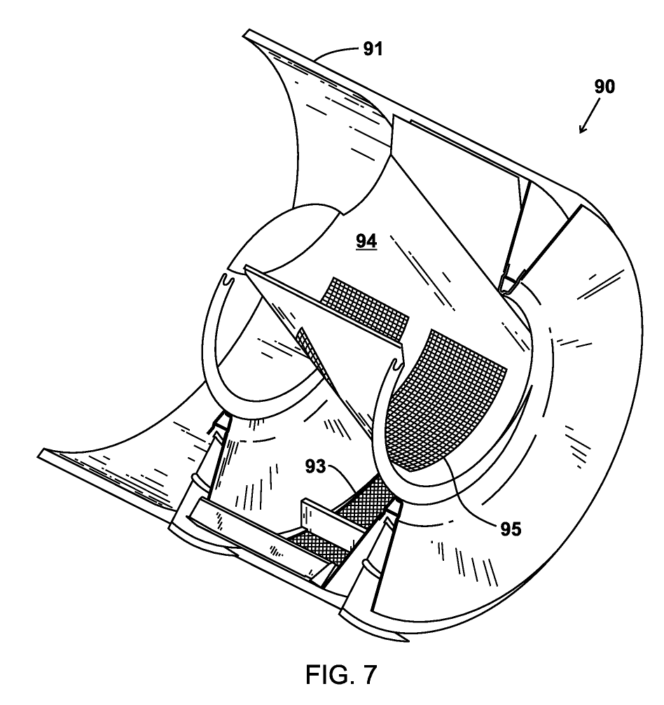

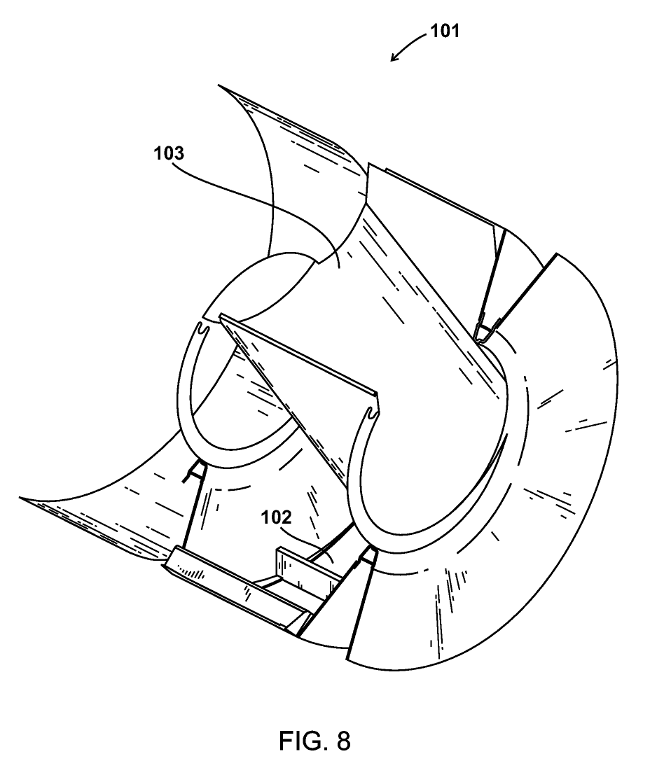

In FIG. 2, module 8 is a rinse module that receives water flow from line 23. That rinse water then flows to junction or cross fitting 40. In FIG. 2, the modules 1, 4-5 and 8 are modules with outer shells 91. In FIG. 2, module 8 or modules 8 and 9 can have an outer shell 91. In FIG. 3, the modules 1, 5-6 and 10-12 are modules with outer shells 91. Module 9 could optionally have a shell 91 in FIG. 2. In FIG. 2, modules 2, 3, 6 and 7 do not have an outer shell 91. In FIG. 2, modules 4 and 8 preferably have perforated scoops. In FIG. 2, modules 1-3, 5-7 and 9 preferably do not have perforated scoops. Modules having shells and/or perforated scoops can be seen in FIGS. 7-8.

Recirculation flow lines 59, 60 transmit flow from module 1 to hopper 16. Pump 61 receives flow from line 59 and discharges flow to line 60. In FIG. 2, module 8 is preferably a rinsing drum with perforated scoop. Rinse water from line 23 receives water from tank 21 and directs that water to and through module 8, then to junction or cross fitting 40. Tank 21 can optionally be replenished by fresh water source 17. Tank 21 can optionally be replenished by recirculated rinse water via flow line 43. Tank 21 can optionally receive extracted water via flow lines 55, 39 and extracted water tank 54. Line 39 can have tee fitting 64 and valve 62. Flow line 65 with valve 63 enables discharge of line 39 to sewer 49. Flow lines 33 and 34 enable addition of water to modules 4, 5 respectively in FIG. 2 and in modules 5, 6 respectively in FIG. 3. Flow line 44 enables addition of water to module 5 in FIG. 2 (module 6 in FIG. 3).

In FIG. 3, flow lines 33 and 34 enable addition of water to modules 5-6 respectively. Flow line 44 enables addition of water to module 6. In FIG. 3, modules 1, 5-6 and 10-12 can be modules with outer shells 91. Outer shells 91 are fixed and do not rotate. In FIG. 3, modules 2-4, and 7-9 can be modules with no outer shell 91. In FIG. 3, modules 1, 5 and 10-11 can be modules that each have a perforated scoop as seen in FIG. 7. In FIG. 3, modules 2-4 and 7-9 can be modules each preferably having no perforated scoop. As seen in FIG. 3, it is a similar arrangement to FIG. 2 but with three additional modules 10, 11, and 12. Overflow drains 67 to sewer 49 can be provided in FIG. 2 at modules 1 and 9 and at modules 1 and 12 for FIG. 3. Line 68 enables counterflow from module 5 to module 4 in FIG. 2. Lines 69 enable counterflow from module 6 to module 5 and from module 11 to module 10 in FIG. 3. Drains 72 can be provided at modules 1, 4 and 5 in FIG. 2 (modules 1, 5, and 6 in FIG. 3).

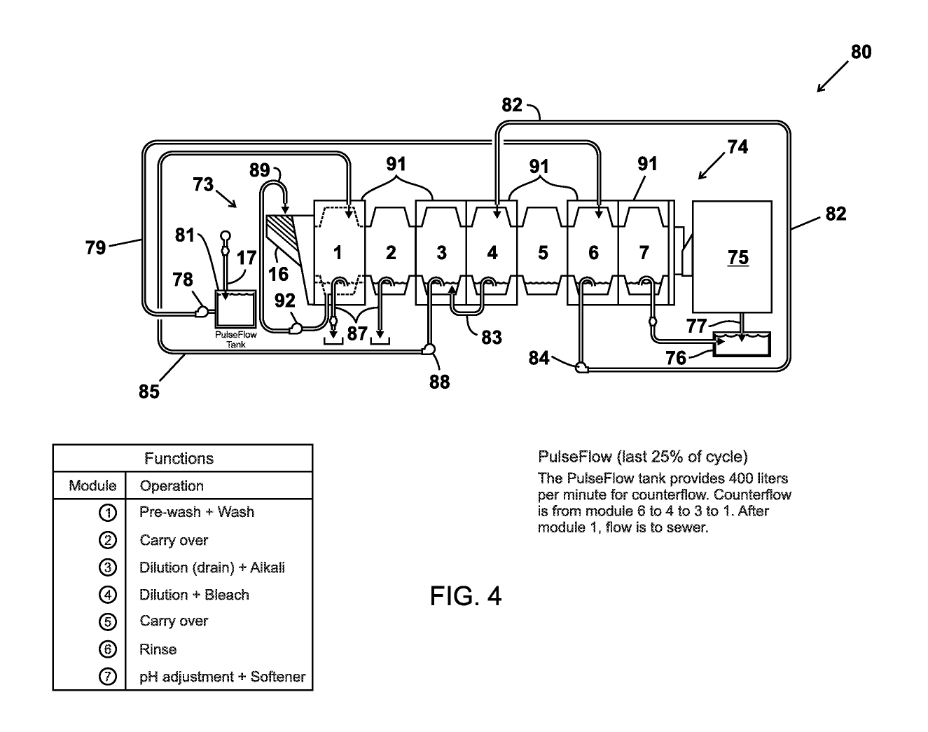

FIGS. 4, 5 and 6 show another embodiment of the apparatus of the present invention. FIGS. 4, 5, and 6 are similar in that some modules have outer shells, some modules have perforated scoops, some modules have no outer shell (and are thus less expensive to construct), and some modules have scoops that are not perforated.

In FIGS. 4, 5, and 6, high speed, high flow counterflow rinsing is combined with lower cost modules that do not require an outer shell to provide better dilution than prior art washers that have all modules with no shells.

FIG. 4 illustrates a seven (7) module embodiment of the present invention designated by the number 80. In FIG. 4, module 1 defines a pre-wash and wash zone. Module 2 is a conveyor module. Module 3 is a drain plus alkali. Module 4 is for addition of chemicals (e.g., dilution plus bleach) and for temperature elevation (e.g., using steam). Modules 3 and 4 also have an outer shell 91. Module 5 is a carryover module. Modules 6 and 7 each have shells 91. Modules 6-7 provide ph and softener.

In the seven (7) module tunnel washer 80 of FIG. 4, the numeral 73 designates an intake end portion while the numeral 74 designates a discharge end portion. As with FIGS. 2-3, washer 80 has an intake chute or hopper 16. An extractor 75 receives fabric articles or linens from module 7 at discharge end portion 74. Tank 76 receives extracted water from extractor 75 via flow line 77.

Modules 1, 3-4 and 6-7 have outer shells 91. Modules 2 and 5 do not have outer shells 91. An outer shell 91 enables addition of water, chemicals, bleach, and steam injection. The outer shells 91 are stationary. Those modules having a shell typically have a perforated scoop. Those modules with no shell do not have a perforated scoop.

Pump 78 transmits fluid/water via flow line 79 from tank 81 to module 6. Fluid/water in module 6 discharges via flow line 82 to module 4 and then counterflows to module 3 via counterflow line 83. Flow line 82 can have a pump 84. From module 3, fluid/water flows via flow line 85 to module 1. Flow line 85 can have pump 88. Modules 1 and 2 can have drains or drain lines 87 to sewer. Module 1 is a prewash and wash module. Module 2 is a carryover module. A flow line 89 can be provided for transmitting water/fluid from module 1 to hopper 16. Flow line 89 can be provided with a pump 92.

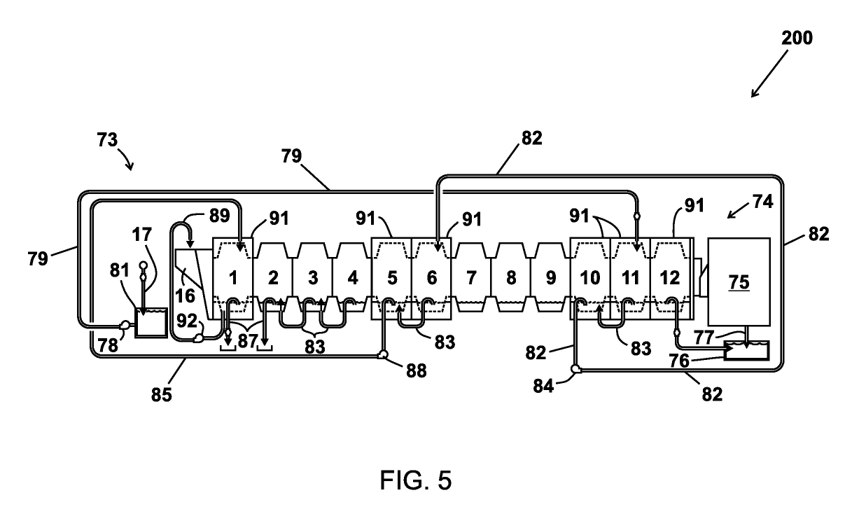

FIG. 5 is a diagram of a twelve (12) module tunnel washer (e.g., top transfer tunnel washer), designated generally by the numeral 200. FIG. 5 is similar to FIG. 4 but adds modules without outside shells downstream of module 1. In FIG. 5, modules 2, 3 and 4 are modules without outside shells and without a perforated scoop. In FIG. 5, module 1 is a pre-wash module. Modules 2, 3, and 4 are carryover modules. Module 5 is a dilution (drain) plus alkali (or other chemical) addition modules. Module 6 is a dilution plus bleach (or other chemical) addition module. Modules 1, 5 and 6 have outer shells 91. Modules 7, 8 and 9 are carryover modules. Modules 10 and 11 are rinse modules having outer shells 91. Module 12 is a ph adjustment and softener (or other chemical) addition module.

In FIG. 5, tanks are provided at 76, 81. Tank 76 is an extracted water tank. Tank 81 is a tank using fluid/water for counterflow at a high flow rate (e.g., 400 cubic feet per minute (11.33 cubic meters per minute)). In FIG. 5, counterflow is from module 11 to module 10 to module 6 to module 5 to module 1 using flow lines 83, 82 and 85. Flow line 79 can have a pump 78. Flow line 82 can have a pump 84. Flow line 85 can have a pump 88. Counterflow lines 83 are provided between modules 6 and 5 (for counterflow from module 6 to module 5) for counterflow from module 4 to module 3 and from module 3 to module 2. A flow line 89 can be provided for transmitting water/fluid from module 1 to hopper 16. Flow line 89 can be provided with a pump 92.

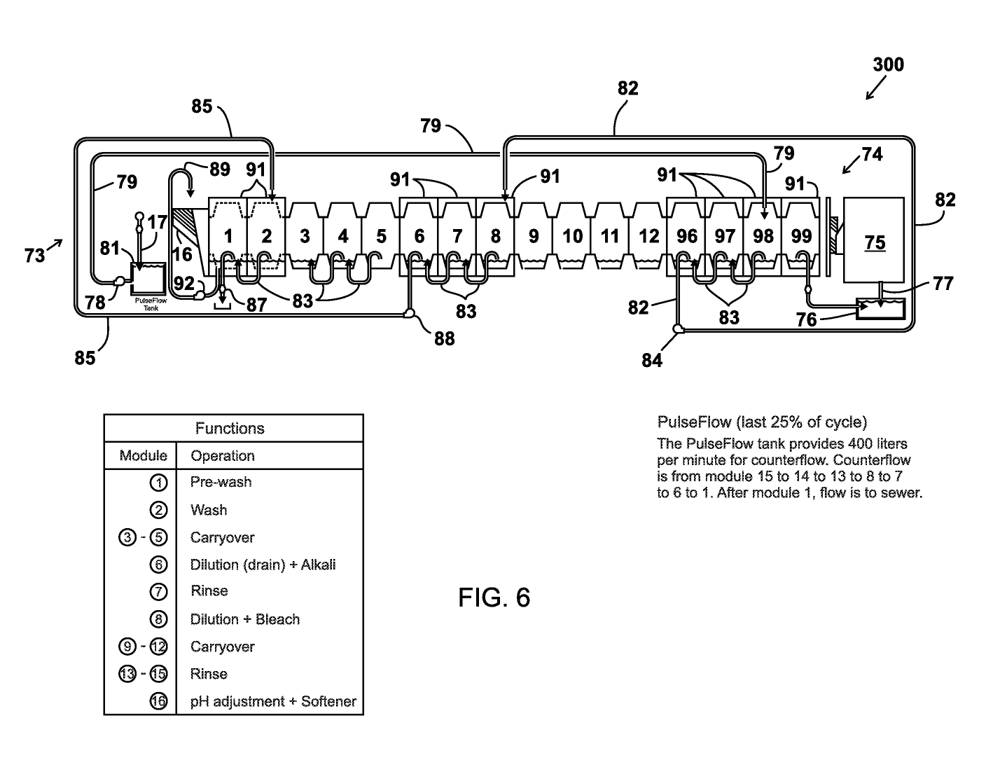

FIG. 6 shows a sixteen (16) module apparatus, designated generally by the numeral 300. FIG. 6 is similar to FIG. 5 but with additional modules 96, 97, 98, 99. Module 1 is a prewash module. Module 2 is a wash module. Modules 1 and 2 have outer shells 91. Modules 3, 4, and 5 are carry over modules.

Module 6 is a dilution (drain) plus chemical addition (e.g., alkali) module. Module 7 is a rinse module. Module 8 is a dilution plus chemical addition (e.g., bleach) module. Modules 6, 7 and 8 have outer shells 91 and perforated scoops. Modules 9, 10, 11, 12 are carry over modules with no perforated scoops. Modules 96-98 are rinse modules. Module 99 is a ph adjustment and chemical addition (e.g., softener) module. Otherwise, FIG. 6 operates as FIGS. 4 and 5 with counterflow flow lines 82, 83, 85 and fluid holding tanks 76, 81 as shown in FIG. 6.

The present invention improves washing and rinsing functions as pulse flow velocity rinsing (e.g., flow lines 79, 82 and 85) replaces continuous counterflow. Because of the efficiency of the high velocity (e.g., about 80 to 180 GPM (about 302.83 to 681.37 liters per minute) in a preferred embodiment of the present invention), fewer modules or drums are required for the same level of dilution. The rinsing modules or drums 90 (see FIG. 7, i.e., modules 4, 5 and 8 in FIG. 2 and modules 1, 5-6, 10-12 in FIG. 3) preferably have scoops 94 with perforations 95 and an outer shell 91 to improve rinsing efficiency. Inner shell 93 and scoop 94 rotate together. In most applications, preferably only one rinsing drum or module 90 is required. Each module or drum 90 preferably has a scoop 94 with perforations at 95 and a perforated inner wall at 93 to drain the free water when transferring to the next module or drum.

Drums or modules without shells are carryover modules 101 (see FIG. 8) and preferably have scoops (for linen transfer) with no perforations 103. Thus, the linen (fabric articles) and all water preferably goes to the next downstream drum or module; carryover modules 101 have no outer shell 91 but have inner shell/inner wall 102 with no perforations and scoop 103 that rotate together. The present invention has much lower manufacturing cost. Fewer drums results in lower cost with improved washing and rinsing.

The following is a list of parts and materials suitable for use in the present invention:

### PARTS LIST

| Parts Number | Description |
|---|---|
| 1 | module/drum |
| 2 | module/drum |
| 3 | module/drum |
| 4 | module/drum |
| 5 | module/drum |
| 6 | module/drum |
| 7 | module/drum |
| 8 | module/drum |
| 9 | module/drum |
| 10 | module/drum |
| 11 | module/drum |
| 12 | module/drum |
| 13 | inlet/inlet end portion |
| 14 | outlet/outlet end portion |
| 15 | washing machine apparatus/tunnel washer |
| 16 | hopper |
| 17 | fresh water source |
| 18 | flow line |
| 19 | flow meter |
| 20 | valve |
| 21 | tank |
| 22 | pump |
| 23 | flow line |
| 24 | valve |
| 25 | flow meter |
| 26 | tee fitting |
| 27 | tee fitting |
| 28 | tee fitting |
| 29 | tee fitting |
| 30 | flow line |
| 31 | valve |
| 32 | flow line |
| 33 | flow line |
| 34 | flow line |
| 35 | valve |
| 36 | flow meter |
| 37 | valve |
| 38 | valve |
| 39 | flow line |
| 40 | junction/cross fitting |
| 41 | valve |
| 42 | valve |
| 43 | flow line |
| 44 | flow line |
| 45 | pump |
| 46 | pump |
| 47 | flow line |
| 48 | valve |
| 49 | sewer |
| 51 | valve |
| 52 | meter |
| 53 | chemical injector |
| 54 | extracted water tank |
| 55 | flow line |
| 56 | valve |
| 57 | pump |
| 58 | valve |
| 59 | flow line |
| 60 | flow line |
| 61 | pump |
| 62 | valve |
| 63 | valve |
| 64 | tee fitting |
| 65 | flow line |
| 66 | steam inlet |
| 67 | overflow drain |
| 68 | flow line |
| 69 | flow line |
| 70 | flow line |
| 71 | booster pump |
| 72 | drain/drain valve |
| 73 | intake end portion |
| 74 | discharge end portion |
| 75 | extractor |
| 76 | extracted water tank |
| 77 | flow line |
| 78 | pump |
| 79 | flow line |
| 80 | washing machine apparatus/tunnel washer |
| 81 | tank |
| 82 | flow line |
| 83 | flow line |
| 84 | pump |
| 85 | flow line |
| 87 | drain/drain line |
| 88 | pump |
| 89 | flow line |
| 90 | module/drum |
| 91 | outer shell |
| 92 | pump |
| 93 | perforated inner shell/inner wall |
| 94 | scoop |
| 95 | perforation |
| 96 | module |
| 97 | module |
| 98 | module |
| 99 | module |
| 101 | carry over module |
| 102 | inner shell/inner wall with no perforations |
| 103 | scoop without perforation |
| 111 | top transfer tunnel washer |
| 120 | arrow |
| 121 | module |
| 122 | fabric articles/linens/goods |
| 123 | bath liquor |
| 124 | arrow |
| 125 | scoop |
| 126 | cylinder |
| 127 | arrow |
| 128 | arrow |
| 129 | module |
| 200 | washing machine apparatus/tunnel washer |
| 300 | washing machine apparatus/tunnel washer |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A method of washing fabric articles in a continuous batch tunnel washer, comprising the steps of:
a) providing a continuous batch tunnel washer having an interior, an intake, a discharge, a plurality of modules, and a volume of liquid;
b) moving the fabric articles from the intake to the modules and then to the discharge in sequence;
c) wherein in step “b” one or more of the modules have a perforated scoop;
d) not counter flowing a rinsing liquid in the washer interior for a selected time interval after step “c”;
e) after step “d”, counter flowing a rinsing liquid along a flow path that is generally opposite the direction of travel of the fabric articles in steps “b” and “c” and first and second at spaced apart positions;
f) during step “e” boosting pressure of the counter flowing rinsing liquid with a booster pump at one or more positions spaced in between the intake and the discharge; and
g) wherein there are multiple said modules that each have a perforated scoop and a shell and multiple modules that have no shell and no perforated scoop.

2. The method of claim 1 wherein in step “f” multiple booster pumps are provided, each pump boosting counter flowing rinsing liquid flow rate at a different one of said modules.

3. The method of claim 1 wherein multiple modules receive counterflow at spaced apart positions and wherein one or more modules having no perforated scoop are in between said first and second positions.

4. The method of claim 2 wherein the booster pumps are spaced apart by more than one module.

5. The method of claim 2 wherein in step “f” the booster pump discharges liquid into a module that has an outer shell.

6. The method of claim 2 wherein the booster pumps each discharge liquid into a module that does not have a perforated scoop.

7. The method of claim 5 wherein flow is substantially halted for a time period that is less than about five minutes.

8. The method of claim 5 wherein flow is substantially halted for a time period that is less than about three minutes.

9. The method of claim 5 wherein flow is substantially halted for a time period that is less than about two minutes.

10. The method of claim 5 wherein flow is substantially halted for a time period that is between about twenty and one hundred twenty (20-120) seconds.

11. A method of washing fabric articles in a continuous batch tunnel washer, comprising the steps of:
a) providing a continuous batch tunnel washer having an interior, an intake, a discharge, and a plurality of modules that segment the interior;
b) moving the fabric articles from the intake to the discharge;
c) adding a washing chemical to the modules;
d) after a selected time interval and after step “c”, counter flowing liquid in the washer interior along a flow path that is generally opposite the direction of travel of the fabric articles in step “b”;
e) counter flowing water through the modules to effect a rinse of the fabric articles;
f) wherein some of the modules have an outer shell and some of the modules do not have an outer shell; and
g) wherein one or more of the modules having a shell have a perforated scoop and one or more of the modules has no shell and no perforated scoop.

12. A method of washing fabric articles in a continuous batch tunnel washer, comprising the steps of:
a) providing a continuous batch tunnel washer having an interior, an intake, a discharge, and a plurality of modules that segment the interior;
b) moving the fabric articles from the intake to the discharge and through the modules in sequence;
c) adding a washing chemical to the modules;
d) washing the fabric articles;
e) after completion of steps “c” and “d”, rinsing the fabric articles by counter flowing liquid in the washer interior along a flow path that is generally opposite the direction of travel of the fabric articles in step “b”; and
f) wherein one or more of the modules are rinse modules that have a perforated scoop;
g) wherein some of the modules do not have a perforated scoop; and
h) wherein one or more of the rinse modules has a shell.

13. A method of washing fabric articles in a continuous batch tunnel washer, comprising the steps of:
a) providing a continuous batch tunnel washer having an interior, an intake, a discharge, a plurality of modules, and a volume of liquid;
b) moving the fabric articles from the intake to the modules and then to the discharge in sequence;
c) wherein in step “b” one or more of the modules has a perforated scoop and has an outer shell;
d) counter flowing a rinsing liquid at spaced apart first and second positions along a flow path that is generally opposite the direction of travel of the fabric articles in steps “b” and “c”;
e) during step “e” boosting pressure of the counter flowing rinsing liquid with a booster pump at one or more positions spaced in between the intake and the discharge; and
f) carrying over the fabric articles with a module that does not have a perforated scoop in between said first and second spaced apart positions.

14. The method of claim 13 wherein there are multiple said modules with perforated scoops.

15. The method of claim 13 wherein in step “f” the booster pump discharges liquid into a module that has an outer shell.

16. The method of claim 13 wherein the booster pump discharges liquid into a module that does not have a perforated scoop.

17. The method of claim 15 wherein flow is substantially halted for a time period after step “c”.

18. The method of claim 17 wherein flow is substantially halted for a time period that is less than about three minutes.

19. The method of claim 17 wherein flow is substantially halted for a time period that is less than about two minutes.

20. The method of claim 17 wherein flow is substantially halted for a time period that is between about twenty and one hundred twenty (20-120) seconds.

21. (canceled)
